(19) United States
(12) Patent Application Publication
(10) Pub. No.: US 2019/0090522 A1
(43) Pub. Date: Mar. 28, 2019

(54) Method for Obtaining Etheric Oils and/or Constituents of Etheric Oils from Moist Extraction Material

(71) Applicant: GCR - Global Commodity Resources UG (Haftungsbeschränkt), Neukirch (DE)

(72) Inventors: Anja Glisovic, Lübeck (DE); Stefan Handrick, Neukirch (DE); Frank Hinrichs, Oldenburg (DE)

(21) Appl. No.: 16/094,213

(22) PCT Filed: Apr. 20, 2017
(86) PCT No.: PCT/EP2017/059351

§ 371 Date: Oct. 17, 2018

(30) Foreign Application Priority Data
Apr. 20, 2016 (DE) 10 2016 206 677.3

(51) Int. Cl. A23L 27/10; C11B 9/02; A23L 27/12

(52) U.S. Cl. CPC A23L 27/11; A23L 27/13; A23L 27/115; C11B 9/025

(57) ABSTRACT

The invention relates to a method for obtaining etheric oils and/or constituents of etheric oils from the peel of citrus fruit and/or herbs that have a high residual moisture content comprising the steps
a) extraction of the moist extraction material with an extraction agent mixture comprising at least one polar and at least one non-polar solvent for obtaining a miscella,
   wherein the extraction material is selected from citrus fruit peel and/or residues from the juice production from citrus fruits and/or herbs,
   wherein the extraction material has a residual moisture content of 5 to 95% by mass, measured on the total mass of the extraction material,
   wherein the extraction agent mixture contains at least one non-polar solvent in a proportion of 45 to 95% by volume, measured on the total volume of the extraction agent mixture,
   wherein the extraction agent mixture has a temperature above ambient temperature but below the boiling point of the lowest boiling-point solvent or of the lowest boiling-point azeotrope of the extraction agent mixture;
b) separating the miscella from the extraction material;
c) distillative separation of the miscella or distillative separation of the extraction agent mixture from the etheric oil and/or the constituents of the etheric oils.

### CROSS REFERENCE TO RELATED APPLICATIONS

This application is the U.S. national stage of International Application No. PCT/EP2017/059351, filed on 2017 Apr. 20. The international application claims the priority of DE 102016206677.3 filed on 2016 Apr. 20; all applications are incorporated by reference herein in their entirety.

### BACKGROUND

The present invention relates to a method for obtaining etheric oils and/or constituents of etheric oils from the peel of citrus fruit and/or herbs that have a high residual moisture content. The method also enables a rough, optional separation of the constituents of the etheric oils corresponding to their polarity and solubility.

Secondary plant constituents that have extracts which are soluble in organic solvents or which form the organic phase from steam distillates of plants or plant parts and have a strong characteristic odor of the original plant are designated here as etheric oils. Etheric oils are for the most part made of mixtures of different terpenes, terpenoids, sesquiterpenes or aromatic compounds (e.g. phenyl propane derivatives). They are fat soluble, but contain no fat. In contrast to fatty oils, such as triglycerides and fatty acid esters, etheric oils vaporize in a residue- free manner. They are only very slightly soluble in water. At normal pressure, the boiling point of etheric oils and their constituents is above that of water; they are distilled by super-heated steam, however. They generally have a lower density than water and therefore form floating phases on the water surface (drops, films and layers).

Etheric oils are obtained in conventional methods either by steam distillation, by cold pressing or, in rare cases, by solvent extraction. Lemon and orange oils in particular are obtained by steam distillation and cold pressing and are distinguished by a high proportion of limonene.

The most common method for obtaining etheric oils is steam distillation. For this, hot steam is injected into a closed combustor vessel with comminuted plant material. The steam forces the etheric oil or the etheric oils out of the plants. The etheric oil-water mixture (miscella) condenses in a chilled tube and is collected in a container. A phase separation of the miscella into an organic and an aqueous phase takes place there, and they are then separated by extraction. A majority of the etheric oils form the organic phase, but parts of the typical compounds also remain behind in the aqueous phase and thus form “aromatic waters” such as orange or rose water. Some plants whose etheric oils cannot be distilled alone, such as nettle or hay, can be distilled together via co-distillation with another plant whose etheric oils serve as a carrier substance. The disadvantage of steam distillation is the high energy and time expenditure. The distillation of some plants can last up to six hours and even a normal steam distillation with a process duration of one to three hours is very time-intensive.

With some plants, there is the possibility of obtaining etheric oils by cold pressing. Cold pressing is employed for citrus and orange oil, for example, both etheric oils based on terpenes and terpenoid mixtures. In cold pressing, the peels, mostly in a comminuted form, are pressed in a single work step. A filtration can take place subsequently. Different presses are used depending upon the requirement and technical development. Although spindle presses were already used in antiquity, screw presses, whose productivity is substantially higher when compared to spindle presses, are mainly used today. In both variants, only a low frictional heat is created during the pressing. The alternation between compression and expansion of the pressed material is critical for the frictionless process of the pressing procedure. The expansion promotes the oil flow from the pressed material to the filter. The emulsion (miscella) of aqueous fluid and etheric oils exiting from the press still contains approx. 0.5 to 0.6 percent solids (particles) by weight that accelerate the ageing of the etheric oil; the miscella must therefore be purified by sedimentation and filtration. Disadvantageously, this leads to a loss of a part of the etheric oil. The miscella is next separated into etheric oil and water by centrifugation. The low etheric oil content of the starting material (around 4% weight by mass of the dry mass in the case of orange peels, for example) leads to a very low content of etheric oil in the miscella. Large amounts of miscella must therefore be processed in order to obtain economically usable amounts of etheric oil. This disparity has a negative impact in high production costs and the low efficiency of the method.

Etheric oils of some flower types, such as jasmine, tuberose or mimosa, cannot be obtained by steam distillation or cold pressing; an extraction method for obtaining the so-called absolute (highly-concentrated oily fragrance) is generally used here. Obtaining the absolute takes place by extraction. At room temperature, the dry plant parts are placed in non-polar solvents such as hexane, petroleum ether, toluene, methanol or ethanol. The solvent is next removed via cooling, filtration and steaming; a solvent-free paste results, the concrete, to which alcohol is next added and filtered, the absolute. It finds, inter alia, use in perfumes. This recovery process is more gentle than extraction via steam distillation because of the low temperatures. The fragrance is thus closer to the fragrance of the plant; a disadvantage is that an energy-intensive prior drying step of the plant parts is necessary.

AU000005494294A and CN000104940342A describe an additional possibility for the extraction of etheric oils. Disclosed here is the treatment of plants from the family Rubiaciae (Hedyotis caudatifolia) with supercritical CO₂, wherein the plant material is dried and pulverized before extraction. The etheric oil transitions into the sc-CO₂ phase during a circulation extraction and is obtained by decompression in a separation vessel.

The currently established industrial standard is, however, the obtaining of etheric oil from plant materials via steam distillation, which is particularly well-suited for extraction of moist materials.

Plant parts generally have a water content of more than 70% and drying would carry a disproportionately high energy expenditure. In order to avoid this drying, the disadvantages of steam distillation such as high energy expenditure, oxidative stress and loss of a certain proportion of the etheric oils in the “fragrance waters” is taken into account. Steam distillation plants can also only operate in batch runs, which limits the throughput. For steam distillation, as is also common to the other methods named, it is hardly possible to undertake a rough separation of the etheric oils into their constituents or constituent groups, even during the process, which makes a later, costlier separation necessary. Disadvantageously this leads to higher costs that affect, above all, the pharmaceutical industry, which often requires the pure compounds. Disadvantageously, this is also mostly batch processes, meaning a discontinuous process.

A possibility of continuous extraction, as is the industrial standard for obtaining fatty plant oils via hexane extraction, would be advantageous. These advantages are seen, for example, in the low price of rapeseed oil, which is obtained industrially via continuous hexane extraction.

The continuous solvent extraction for obtaining etheric oils or their constituents is techno-physically problematic, however. For etheric oils, non-polar solvents such as n-hexane, toluene, etc. must be used. To do this, the etheric oil-containing material must first be dried and comminuted (conditioned) and then extracted. Because plants important for obtaining etheric oils usually have a high water and a low oil content, it is a disadvantage in this method that a high application of energy is necessary for drying. In addition, there is a significant loss of the volatile etheric oils during drying. The separation of the etheric oil from the solvent takes place next by distillation, wherein the etheric oil is present as a mixture and must then be separated into its constituents if, for example, varietally pure compounds are to be obtained for chemical and pharmacological products.

Different methods for obtaining etheric oils and/or constituents of etheric oils via extraction are previously known:

In EP 0617119A2, a method for simultaneous extraction of hydrophobic triterpenoids such as azadirachtin from the dry seed of the neem tree is disclosed.

Disadvantageously, only dry materials can be extracted here and the disclosed extraction solvents all have an excess of alcohol. The method represented is also not optimized for obtaining monoterpenes, but rather for obtaining hydrophilic constituents.

Patent DE 69623762 T2 describes a method for obtaining diterpenes such as cafestol ester, kahweol ester and isocafestol ester via processing of coffee grounds with phosphoric acids and a subsequent extraction of diterpenes after drying. Disadvantageously, the coffee grounds must also be dried before the extraction and processed with phosphoric acids. The diterpenes are then present in esterified form.

EP 1196519 B1 describes a method for obtaining etheric oils from a material containing etheric oil. A steam distillation or extraction takes place first here in order to produce a mixture containing etheric oils. This is bonded with a hydrophobic adsorbent made of silicas or activated charcoal, wherein the hydrophobic etheric oils are adsorbed. The remaining hydrophilic phase is returned to the steam distillation and the etheric oils are desorbed from the adsorbent.

A significant source of etheric oils is citrus fruits. Even the residues of juice production from citrus fruits, of which several thousand tons are disposed of each year, represent an important resource.

Different methods are known for obtaining etheric oils or constituents of etheric oils from citrus fruit.

US 20130109065 and U.S. Pat. No. 9,253,996 B2 describe a method for extracting limonene and pectin from citrus wastes via a specialized variant of steam distillation. In the methods described, the citrus peels are first comminuted and heated via injection of steam and then steam exploded. The aqueous material thus created is transferred into an additional boiler and heated so that the limonene transitions into the gas phase.

CN 104628509 also describes a variant of steam distillation for obtaining limonene. Here, orange peels are treated with an addition of ammonium chloride and then subjected to steam distillation.

WO 2008074072 A1 describes a method for extracting chemical substances via super-critical water, induced by ultrasound.

In WO 2013155850 A1, a method for obtaining etheric oil from the peel of grapefruit is described. In the first step, the outer peels are peeled/grated from the fruit to a depth of 2 to 3 mm. In the second step, the peels are frozen, and the etheric oils are then pressed out in an extruding press while salt is added.

EP 2844677 A1 discloses a method for sequentially obtaining limonene, pectin and other materials from the peels of citrus fruits. In a first step, the material is comminuted and hydrothermally disintegrated using microwave radiation; mechanical and chemical separation steps take place next. Here, this is again a classic extraction method using a solvent, a press or steam distillation.

U.S. Pat. No. 4,497,838 describes a method for extraction from citrus peels, specifically orange peels. The peels are comminuted in a first step and then extracted using a solvent from the group of non-aqueous, but water-miscible solvents, such as lower alcohols, in particular methanol, ketone, etc., mixed with water. In this manner, sugars, as well as etheric oils and bioflavonoids are released from the peel and separated in additional method steps.

### SUMMARY

The invention relates to a method for obtaining etheric oils and/or constituents of etheric oils from the peel of citrus fruit and/or herbs that have a high residual moisture content comprising the steps
a) extraction of the moist extraction material with an extraction agent mixture comprising at least one polar and at least one non-polar solvent for obtaining a miscella,
   wherein the extraction material is selected from citrus fruit peel and/or residues from the juice production from citrus fruits and/or herbs,
   wherein the extraction material has a residual moisture content of 5 to 95% by mass, measured on the total mass of the extraction material,
   wherein the extraction agent mixture contains at least one non-polar solvent in a proportion of 45 to 95% by volume, measured on the total volume of the extraction agent mixture,
   wherein the extraction agent mixture has a temperature above ambient temperature but below the boiling point of the lowest boiling-point solvent or of the lowest boiling-point azeotrope of the extraction agent mixture;
b) separating the miscella from the extraction material;
c) distillative separation of the miscella or distillative separation of the extraction agent mixture from the etheric oil and/or the constituents of the etheric oils.

### DETAILED DESCRIPTION

The object of the present invention is to provide a simple and economically efficient method for extracting plant extraction material having a high residual moisture content for obtaining etheric oils or constituents of etheric oils that optionally also enables a rough separation of the constituents of the etheric oils and can also be applied on a large scale / industrially.

The object is achieved by a method for obtaining etheric oils and/or constituents of etheric oils from moist extraction material with the steps
a) extraction of the moist extraction material with an extraction agent mixture comprising at least one polar and at least one non-polar solvent for obtaining a miscella,
   wherein the extraction material is selected from citrus fruit peel and/or residues from the juice production from citrus fruits and/or herbs,
   wherein the extraction material has a residual moisture content of 5 to 95% by mass, measured on the total mass of the extraction material,
   wherein the extraction agent mixture contains at least one non-polar solvent in a proportion of 45 to 95% by volume, measured on the total volume of the extraction agent mixture,
   wherein the extraction agent mixture has a temperature above ambient temperature but below the boiling point of the lowest boiling-point solvent or of the lowest boiling-point azeotrope of the extraction agent mixture;
b) separating the miscella from the extraction material;
c) separation by distillation of the miscella or separation by distillation of the extraction agent mixture from the etheric oil and/or the constituents of the etheric oils.

According to the invention, the moist extraction material is extracted with an extraction agent mixture made of at least one each of a polar and a non-polar solvent for obtaining a miscella.

Miscella indicates a material mixture of an extraction agent and/or an extraction agent mixture and at least one extracted etheric oil and/or constituent of an etheric oil.

According to the invention, the extraction material contains etheric oils and/or constituents of etheric oils.

Etheric oils and/or constituents of etheric oils according to the invention include terpenes, sesquiterpenes, terpenoids and/or aromatics and/or terpene- sesquiterpene-terpenoid aromatic mixtures, preferably the compounds specified in Table 2, in particular on the basis of monocyclic monoterpenes, specifically having a high proportion of limonene.

The extraction material preferably contains terpenes, terpenoids, sesquiterpenes and aromatic compounds, in particular based on monoterpenes. Most monocyclical monoterpenes that can be derived from p-menthane have a cyclohexane structure. There are, however, a plurality of compounds with cyclopropane and cyclobutane structures (chrysanthemum acids cinerin I and chrysanthemol) or with a cyclopentane structure, such as grandisol and junionon. The material with the smallest known aroma threshold value, thioterpineol, can also be categorized here.

The monocyclic terpenes with a cyclohexane structure are mostly subdivided under their secondary material group affinity, as is indicated in Table 2 in the appendix, for example. The most important hydrocarbon materials here are menthane, limonene, phellandrenes, terpineols, terpenes and p-cymene. Menthane is seldom found in nature in comparison to the other monoterpene hydrocarbons. Limonene occurs very commonly in a wide variety of plants, terpineols and terpenes are fragrance materials and constituents of etheric oils, terpineol is also an alarm pheromone of termites. Phellandrenes are found in caraway, fennel and eucalyptus oil. p-cymene is found in simple savory.

Menthol is the main constituent of peppermint oil, it is an analgesic and is used for additional medicinal applications. Pulegone is also found in peppermint oils.

Piperitol occurs in eucalyptus and peppermint varieties. Terpineol is a fragrance substance. Carveol is found in citrus oils. Thymol is found in the etheric oils of thyme and oregano. Dihydrocarveol occurs in caraway, pepper, celery and mint. Anethol is found in anise and fennel.

Menthone and pulegone, as well as their isomers are contained in peppermint oils, as is menthol. Phellandrene is found in water fennel oil. Carvone and carvenone are found in caraway and dill, piperitone in eucalyptus oils.

1,4-cineol and 1,8-cineol are bicyclic terpenes that are bridged via an ether bridge. 1,8-cineol has a bactericidal effect and is primarily found in eucalyptus and laurel and, along with 1,4-cineol, in juniper. Ascaridol, a peroxide, is found in goosefoot varieties.

Rose oxide and nerol oxide are fragrance substances of rose oil.

There are around 200 monoterpenes having a cyclopentane structure. They are divided into the iridoids and secoiridoids. The compounds were first discovered in a type of ant (Iridomyrmex) and are thus some of the few terpenes of non-plant origin. They are distinguished by a base structure that contains one six-membered and one five-membered ring (cyclopentane pyran structure). Terpenoids that no longer belong to the terpenes arise via outward transfer of carbon molecules from the base structure. Acubin and catalpol from ribwort (Plantago lanceolata), for example, belong to the iridoids, as well as loganin from buckbean. Iridiods and iridioglycocides are also contained in valerian (Valeriana officinalis) and rampion (Harpagophytum procumbens).

An extraction agent mixture in the context of the invention is a mixture of solvents that is used for extraction of etheric oils and/or constituents of etheric oils. The etheric oils and/or constituents of etheric oils preferably dissolve in the extraction agent mixture. After extraction, the dissolved and/or undissolved constituents of etheric oils are in the extraction agent mixture. The volume ratio of extraction agent mixture to extraction material is preferably greater than or equal to 1.

In a further exemplary embodiment, the volume ratio of extraction agent to extraction material is less than 1.

According to the invention, the extraction agent mixture comprises one each of a polar and a non-polar solvent. Solvents are classified according to their polarity (hydrophilicity). Polar and non-polar in the context of the invention also indicates which solvent in a comparison of two solvents is the more polar or non-polar solvent. The elutropic series, for example, or the dielectric constant gives a determination on this (see table 1).

The polar and non-polar solvents are preferably miscible with each other without limits, at least in the specified parts by volume. The polar solvent is preferably miscible with the etheric oil and/or at least with one constituent of the etheric oil.

Benzene, kerosene, toluene and/or at least one branched or unbranched alkane with 5 to 25 carbon atoms and/or a mixture of these are preferably used as a non- polar solvent. A branched or unbranched alkane with a chain length of from 5 to 12 carbon atoms or a mixture of these, is particularly preferably used, very particularly preferably selected from n-pentane, iso-pentane, iso-hexane, n- heptane, n-octane, even more preferably n-hexane or a mixture of these.

According to the invention, alkane refers to a saturated, acyclical hydrocarbon with the common formula CₙH₂ₙ₊₂, where n is a whole number. The alkane can be made of a linear carbon structure as well as of its isomers and also branched carbon chains.

Preferably, at least one branched or one unbranched alcohol containing 1 to 10 carbon atoms is used as a polar solvent, particularly preferably 1 to 6 carbon atoms, or a mixture of a plurality of these alcohols. Methanol, ethanol, propanol, butanol, pentanol, decanol, heptanol, octanol, nonanol and/or hexanol and/or the branched isomers of these alcohols or a mixture thereof are very particularly preferably used as a polar solvent. 2-propanol is particularly preferred for use as a polar solvent.

In one embodiment, acetone is used as a polar solvent.

According to the invention, the extraction agent mixture contains at least one non-polar solvent in a proportion of 45 to 95% by volume, measured on the total volume of the extraction agent mixture.

According to the invention, the extraction agent mixture contains at least one non-polar solvent to a proportion of 45 to 95% by volume, preferably 55 to 85% by volume, very particularly preferably 55 to 75% by volume, even more preferably 60 to 70% by volume, measured on the total volume of the extraction agent. The extraction agent mixture is preferably a mixture of at least one polar and at least one non-polar solvent, preferably of one alkane and one alcohol. Appropriate mixtures for the moist extraction described here are thus mixtures with an alkane proportion of at least 50% by weight, preferably 55% to 95% by weight, and in particular 55% by weight to 70% by weight, measured on the total mass of the extraction agent mixture.

The extraction agent mixture preferably contains at least one polar solvent to a proportion of 5 to 55% by volume, particularly preferably to 15 to 45% by volume, very particularly preferably of 25 to 45%, more preferably to 30 to 40% by volume, measured on the total volume of the extraction agent mixture.

In one embodiment, the extraction mixture further contains additional polar and/or non-polar solvents with a proportion by volume of 0.5 to 40% by volume, particularly preferably of 0.5 to 35% by volume, very particularly preferably of 0.5 to 19% by volume, measured on the total volume of the extraction agent mixture. The additional polar and/or non-polar solvents are selected from the polar and non-polar solvents according to the invention.

Alternatively—but not exclusively—binary, tertiary or higher mixtures of different alcohols such as methanol, ethanol, propanol and butanol, etc. can be used as a polar solvent and mixtures of pentane, hexane, heptane, benzene or kerosene and the like can be used as a non-polar solvent. But mixtures based on acetone or toluene are also possible.

It is preferred that the at least one polar solvent is miscible with water, as well as with the at least one non-polar solvent. Advantageously, it is thus possible to extract the extraction material directly, without undertaking drying or with only a limited drying.

The mixing ratio of the extraction agent is of particular significance and relates directly to the properties of the material to be extracted, in particular to the water and etheric oil content of the material, the porosity of the carrier material and the polar properties of the etheric oil, of the solvent and of the organic material. If one views the moist material containing the etheric oil as an open, porous foam in which etheric oil drops are randomly distributed, is becomes clear that the etheric oil cannot leave the foam without passing through the hydrophilic, and thus oleophobic, regions. At the same time, pure hexane as a solvent cannot penetrate deeply into the material because it is repelled by the predominantly hydrophilic walls of the material. In this case, only the etheric oil drops/particles that are near the surface are able to transfer into the oleophilic hexane and be dissolved. If, however, an alcohol is added to the solvent, the alcohol can then advantageously change the local conditions because of its amphiphilic properties. Because of its amphiphilic properties, the alcohol molecules preferably settle on the boundary surfaces of the hydrophobic solvent and of the hydrophilic material walls. There, they locally reduce the hydrophobicity of the pores so that the solvent can penetrate more deeply into the material and, in the optimal case, can completely pass through. This allows it to reach all regions of the material that contain etheric oil and to transfer the etheric oil into the solvent because this is advantageous for the etheric oil in terms of energy. Corresponding to this model, the optimal alcohol-hexane mixture is achieved if the hydrophilic pore surface area of the material can be completely covered with alcohol molecules. If there is less alcohol present in the solvent, the extraction efficiency will decrease because not all etheric oil can be reached. If there is too much alcohol present, the alcohol will prevent the transfer of etheric oil into the non-polar solvent because it is now more advantageous in terms of energy for the alcohol to orient itself having its non-polar side chains toward the etheric oil and having the hydrophilic regions facing outward. The surface of the etheric oil thus takes on a hydrophilic characteristic, which in turn prevents contact with the hydrophobic hexane and thus prevents it from dissolving in the hexane. There is also an optimal mixing region that enables an efficient extraction.

According to the invention, the extraction material is selected from the peels of citrus fruits and/or residue of juice production from citrus fruits and/or herbs.

Peels of citrus fruit in the context of the invention refers to all types of peels from citrus fruits, processed or unprocessed, dry and varietally pure as well as undried and/or moist, as well as mixtures of peels of different citrus fruits. The citrus fruit peels can be preprocessed, for example, sorted or ground.

Herbs according to the invention include all types of plants and plant parts, varietally pure or mixed, that contain etheric oils based on terpenes, sesquiterpenes, terpenoids and aromatics. The extraction material is preferably selected from herbs including peppermints, thyme, anise, coriander, rosemary, eucalyptus, salvia and/or lavender.

Mixtures of peels of citrus fruits and residues of juice production can be advantageously used in the method.

Residues of juice production according to the invention include all types of residual material (also peel residues and seeds) as well as waste and by-products from juice production. Peels, peels with residual fruit flesh and cores, as well as mixtures of these are included in this, for example. Residues occur, for example in industrial juice production as well as in private households or the food service industry.

The residues occurring in the industrial production of juices from citrus fruits, such as fruit flesh remains, cores and/or peels are mostly treated for pectin extraction or discarded. Advantageously, this valuable resource for etheric oils can be used in a cost-efficient manner according to the invention because the etheric oils can be obtained without prior drying of the extraction material.

According to the invention, the extraction material has a residual moisture content of 5 to 95% by mass, preferably 10 to 95% by mass, particularly preferably 30 to 90% by mass, very particularly preferably 45 to 85% by mass measured on the total mass of the extraction material. Residual moisture content according to the invention is the content of water that is found in the peels of citrus fruits and/or residual material of juice production and/or herbs.

The extraction material preferably has a content of etheric oil or constituents of etheric oils of 0.005 to 10% by mass in the dry mass (dry matter), particularly preferably of 0.005 to 8% by mass in the dry mass, very particularly preferably of 0.005 to 6% by mass in the dry mass measured on the total dry mass of the peels of citrus fruits and/or residues of juice production.

Total dry mass according to the invention refers to the total mass of the peels of citrus fruits and/or residual material of juice production after their complete drying to constant weight.

Peels of citrus fruits and/or residual material of juice production from citrus fruits are preferably used as extraction material.

Extraction material is particularly preferably used whose etheric oils or constituents of etheric oils have a proportion of limonene of more than 50% weight by mass, particularly preferably more than 75% weight by mass, particularly preferably more than 85% weight by mass, in particular more than 90% weight by mass on the total mass of the etheric oils and/or constituents of etheric oils.

It is advantageous for the efficiency of the process if the extraction material containing the etheric oil has an optimized particle size that represents a compromise between fineness and coarseness. The smaller the particle of the extraction material containing the etheric oil, the faster and more efficiently the extraction agent can penetrate and dissolve the etheric oil and/or the constituents of the etheric oils. If the ratio of surface to volume is too small, the penetration of the extraction agent takes too long. However, the finer the material is, the larger the amount of extraction agent is that remains in the material after the miscella is pulled off. In addition, filtration production in the case of particles that are too small is more expensive.

In one embodiment, the extraction material is conditioned to an average particle size of 0.001 to 10 mm, particularly preferably of 0.01 to 5 mm, very particularly preferably from 0.1 to 2 mm. In a particular embodiment of the invention, the extraction material, measured to at least 30% by mass of the total mass of the extraction material, has an average particle size less than or equal to 2 mm.

The conditioning is preferably accomplished by shredding, chopping or cutting. Particle size in the context of the invention refers to the average size distribution of the particles within an amount of peels of citrus fruits and/or residues of the juice production.

Alternatively or in combination, the extraction material can also be comminuted beforehand in order to obtain an optimal material size. The maximum particle size is thus below 5 mm, preferably below 2 mm.

According to the invention, the extraction agent mixture has a temperature above ambient temperature but below the boiling point of the lowest boiling-point solvent or of the lowest boiling-point azeotrope of the extraction agent mixture.

An azeotrope is a mixture of at least two solvents, the steam phase of which has the same composition as the fluid phase, whereby a separation by distillation of the at least two solvents is not possible.

The efficiency of the extractive process thus increases with a rising temperature, as with all chemical and physical processes. The maximum operating temperature thus corresponds to the boiling point of the most-fluid components of the extraction solution, which can also be an azeotrope of different components.

The temperature is advantageously also selected to be only high enough that the etheric oils or constituents of etheric oils are not changed by the acting heat.

The extraction agent mixture is preferably applied at a temperature of 35 to 69° C., particularly preferably of 50 to 65° C., very particularly preferably of 58 to 63° C.

Advantageously the degree of extraction increases with the use of a warm extraction agent mixture, meaning that with an extraction agent mixture with a higher temperature a greater amount of etheric oil or constituents of etheric oil can be removed than with the same volume of the same extraction agent mixture that only has the ambient temperature.

Advantageously, the extraction can be accomplished in a Soxhlet apparatus or in percolation and continuous conveyor belt systems or batch plants.

The moist extraction according to the invention can, in principle, be operated in all installations that are designed for hexane extraction, such as batch plants for research, industrial percolation and continuous conveyor-belt installations or the Soxhlet apparatus used in the laboratory.

The distillation unit must only be able to be operated at higher temperatures than when using pure hexane because the alcohols generally have higher boiling points than hexane. Where applicable, seals must be used that can withstand alkanes as well as alcohols.

Technically, the extraction is done using extraction plants, which can range from small Soxhlet sets in the laboratory to industrial countercurrent systems. Of these, percolation facilities are the extractor type most often used for the extraction of etheric oil and/or constituents of etheric oils. During percolation, a fluid flows driven by gravity through a porous material bed to a sieve plate, a principle similar to a coffee filter. As the solvent runs down (percolates) through the bed of oil-containing material, the etheric oil is dissolved in the solvent and the miscella is created, which is captured below the sieve plate. Generally the plants are, for reasons of fire protection, operated at a slight vacuum and close to the boiling point of the solvent, for example 69° C. for pure n-hexane, so that the temperature-dependent dissolution and diffusion processes run as quickly as possible. With a suitable selection of the flake size, the residual moisture content, the extraction agent and the temperature, a dissolution efficiency of 98-99% can be achieved. This principle is common to all percolation installations; however, because of the need to achieve a sufficient extraction completeness and a certain material throughput, different variants of percolation extraction facilities are produced that differ greatly depending upon manufacturer and application. It is common to all that the miscella with the highest proportion of etheric oils is always added to the extraction material at the beginning of the process if its oil content is likewise the highest. The miscella is then used with a successively lower proportion of etheric oil in order to reduce the oil content of the extraction material, step by step. The last step includes rinsing with pure solvent, which can be produced during the percolation through the material by absorption of the miscella having the lowest proportion of oil from the most minimal quantities of etheric oils. The extracted material is then discharged and the extraction agent is removed and reclaimed by steam distillation from the de-oiled extraction material. In the present invention, this step can also be replaced by centrifugal filtration.

In the simplest form, the so-called batch plants, such as the SPX e&e Pilot extraction unit that are often found in laboratories and research facilities because of their low material throughput, the extraction agent is added in a permeable strainer basket. The solvent is applied from above and can percolate through the material. Because of the design, the miscella can be continuously withdrawn. Alternatively, the extractor can also be flooded with solvent and only drawn off after a certain retention time. In this embodiment, the extraction agent is processed with separate rinses so that the content of etheric oils and/or constituents of etheric oils of the miscella and of the extraction material is reduced from rinse to rinse. The number of possible rinses here depends directly upon the number and the volume of the tank that is available for storage of the solvent and the miscella with different oil proportions. Depending upon the design, it is also possible to remove the solvent directly in the extraction vessel without discharging from the extraction agent if hot steam is introduced. Batch plants belong to the so- called drop-center facilities.

The so-called flatbed facilities, which are designed for a continuous material stream and are correspondingly used in large plants, should be differentiated from these. The extraction material here is applied with a relatively low bed depth of 0.3 to 1.2 m thickness on a sieve plate so that the extraction agent applied from above can percolate through the material bed. The sieve plate can be designed as a conveyor belt with this and can move along with the material or be implemented in a fixed manner as a chute. In this case, the extraction material is moved forward using augers or chain hoists. Below the sieve plate, there is in both designs a collection container for the miscella divided into sections. The miscella is pumped from each section onto the material of the following section and collected. The number of sections with this is dependent upon the design and the material and is generally between four and twelve, wherein seven to eight sections are most common. In the first section of the miscella tank, which the fresh, just-introduced material covers, is the miscella with the highest proportion of etheric oils and/or constituents of etheric oils that are not again used for extraction, but go to distillation and thus to obtaining the etheric oils and/or constituents of the etheric oils. The miscella with the lowest oil proportion is found in the last section, which is located under the material, which is treated with fresh/pure solvent and then discharged. The advantage of these installations is in the continuous operation. In comparison to batch plants, however, somewhat higher safety standards are necessary, because the solvent-containing, deoiled extraction material must be discharged from the extractor in order to withdraw the solvent via steam distillation or centrifugation.

In a preferred embodiment, the extraction takes place in percolation and continuous conveyor belt plants that are designed for polar and non-polar solvents.

It should be stressed that colorants and suspended objects can transfer from the material into the extract, that are not normally found in etheric oil in a pure hexane extraction. This is caused by the proportion of alcohol that to some extent enables the transfer of hydrophilic substances.

In order to remove these from the etheric oil, an additional filtration step can be integrated into the process, which allows the removal of suspended objects from the etheric oil that may be present.

Advantageously, via the method according to the invention, operating costs in particular and initial investment costs are significantly reduced in comparison to the previously mentioned conventional and unconventional extraction methods. The method according to the invention thus represents a simple and universally applicable, efficient and economical method for extracting etheric oils based on mixtures of terpenes, sesquiterpenes, terpenoids and aromatic compounds from still-moist materials, in particular for peels of citrus fruits and/or residues of juice production. Advantageously, the method according to the invention can be implemented in all conventional extraction facilities with minimal modification, if necessary.

Surprisingly, it has been shown that in an extraction agent mixture of polar and non-polar solvents with a higher proportion of non-polar solvents, etheric oils and their constituents such as, for example, terpenes, sesquiterpenes, terpeoids and aromatic compounds, can be extracted from moist plant material—such as peels of citrus fruits and/or residues of juice production, herbs and medicinal plants—independent of the water content, without drying and with very good yields.

According to the invention, the miscella is separated from the extraction material after the extraction step.

In a particular embodiment of the invention, the extraction material is extracted multiple times with a fresh extraction agent mixture. The extraction preferably takes place one to 10 times, particularly preferably one to 7 times, very particularly preferably one to 5 times, even more preferably three times. Advantageously, the degree of extraction is thus increased, meaning more etheric oil is obtained from the peels of citrus fruits and/or residues of juice production.

A plurality of extraction steps are preferably carried out. Preferably, 2 to 10, particularly preferably 2 to 7, very particularly preferably 2 to 5 extraction steps, in particular 3 extraction steps, are carried out.

The majority of the miscella is preferably separated from the extraction material after each extraction step and the final separation of the miscella from the de-oiled extraction material takes place after the last extraction.

The intermediate steps and also the final separation of the miscella preferably take place via centrifugation, filtration or a combination of both methods.

The individual extraction agent mixtures, which are laden with etheric oils and/or constituents of etheric oils that are obtained after a repeated extraction of the extraction material with fresh extraction agent mixture each time, are preferably combined.

According to the invention, a separation by distillation of the miscella takes place afterward. In the context of the invention, this means the separation by distillation of the solvent or of the extraction agent mixture from the etheric oil and/or the constituents of the etheric oils. The etheric oil is separated by distillation after extraction of the extraction agent mixture.

The separation of the extracted etheric oil from the extraction agent mixture can be accomplished via a plurality of steps, for example, wherein the lightest volatile components are separated first and then successively the heavier volatile components. Advantageously, an extraction agent mixture can be produced again from recovered solvent.

The etheric oil is separated from the solvent via distillation of the miscella. Not only is the etheric oil separated from the extraction solution by the distillation, but the components of the extraction agent can also be separated from each other. If these are captured in the same container and combined, the mixture can be used again as an extraction agent. If the individual components are captured in different containers, the extraction agent in a running operation can be adapted with different proportions of the components to alternative characteristics of the extraction material if the design of the installation permits this, e. g. via appropriate mixing devices and separate capture and storage containers.

Advantageously, using the method according to the invention, 50 to 100% by mass, particularly preferably 65 to 99% by mass, very particularly preferably 70 to 99% by mass of the etheric oils or constituents of etheric oils, measured on the total mass of the etheric oils or constituents of etheric oils in the moist extraction material can be extracted.

Surprisingly, it has been shown that in an extraction agent mixture of polar and non-polar solvents with a higher proportion of non-polar solvents, etheric oils and their constituents such as, for example, terpenes, sesquiterpenes, terpeoids and aromatic compounds, can be extracted from moist extraction material—such as peels of citrus fruits and/or residues of juice production, and/or herbs and medicinal plants—independent of the water content, without drying and with very good yields. According to a particular embodiment of the method according to the invention, the extraction material can be extracted multiple times with fresh extraction agent mixture. The extraction preferably takes place one to 10 times, particularly preferably one to 7 times, very particularly preferably one to 5 times, even more preferably three times. Advantageously, the degree of extraction is thus increased, meaning more etheric oil is obtained from the peels of citrus fruits and/or residues of juice production. The individual extraction agent mixtures that are retained after a repeated extraction of the peels of citrus fruits and/or residues of juice production using a fresh extraction agent mixture each time are advantageously combined. The etheric oils and/or the constituents of etheric oils are removed by distillation from the combined extraction agent mixtures.

The method according to the invention advantageously offers the possibility of separating the etheric oils and/or the constituents of etheric oils in the miscella into polar and non-polar constituents. If the at least one non-polar solvent is the lowest boiling-point component of the miscella, then it is first separated by distillation and the proportion of the polar solvent increases. Correspondingly, during the evaporation of the non-polar solvent the polarity of the solvent mixture can be adjusted between the value of the original mixture and that of the solvent mixture minus the non-polar solvent. This allows for separation of targeted constituents.

In a preferred embodiment, the separation by distillation of the non-polar solvent from the separated miscella takes place first. The separation of the separated non- polar constituents of the etheric oil from the remaining residue from polar solvent and etheric oil then takes place.

In the simplest case of a binary mixture of n-hexane and 2-propanol and the complete separation of the hexane, there remains a mixture of 2-propanol and etheric oil. 2-propanol has a dielectric constant of 18.2, hexane of 1.9, see Table I. The dielectric constant can be taken as a measure for the polarity of a material. Via the displacement of the polarity of the solvent mixture, the non-polar constituents of the etheric oils separate from the polar solvent with the polar constituents dissolved therein and can be separated by means of a separation funnel, for example. If the polarity of the remaining mixture is further increased by the addition of water, for example, additional, preferably non-polar constituents of the etheric oil can be separated. This opens up previously impossible processing pathways for decomposing etheric oils into their constituents or constituent groups and differentiates the process from the extraction of triglycerides, fatty oils such as coffee, rapeseed, soy or sunflower oils and the previously known extraction methods. This can also be used to free the etheric oils from contaminants. The needles of, for example, black and mountain pines also have, in addition to etheric oils such as those used in cooling baths, a wax coating. If the proportion of hexane in the extraction mixture is reduced, the wax precipitates out and can be easily separated mechanically, for example, using a separating funnel or filtration, with a solvent mixture that contains the etheric oil. A cooling can support this process.

The present method essentially refers to a method for increasing the solvent efficiency of the extraction of moist materials that, for the first time, makes it possible to extract etheric oils and their constituents from moist material containing them without previous drying in an energy- and cost-efficient manner. The extraction mixtures according to the invention also open up the possibility of purifying etheric oils according to their polarity and solubility and roughly decomposing them into their constituents / constituent groups, which was not possible up to now.

It is recommended to combine the different embodiments with each other for execution of the invention.

### DETAILED DESCRIPTION OF THE PREFERRED EMBODIMENTS

The invention is explained in detail with reference to the listed exemplary embodiments without being limited to them.

### EXAMPLE 1

### Moist Extraction of Peels of Navel Pranges (Juice Oranges), Bitter Oranges (Seville Oranges), Lemons or Citrons

Navel oranges were washed and rinsed and peeled. The peels were comminuted into 1-2 mm-sized pieces. The comminuted peels were separated into batches of 102.8 g to 104.3 g.

In order to determine the oil content of the peels to be extracted, a batch weighing 102.8 g was first dried for 3 h at 100° C. until no further weight loss could be observed. The dried batch weighed 21.3 g. The water content of the peels in this batch was therefore 79.3%. The dried peels were extracted for 3 hours with 150 ml hexane in a Soxhlet. The resulting extract was weighed and the hexane evaporated at 90° C. In total, 1.04 g of orange oil was obtained from the extract in this manner. This corresponds to an oil content of 0.97% of the moist mass and 4.88% of the dry mass.

In order to determine the optional composition of the extraction agent mixture, additional batches between 102.8 g and 104.3 g of orange peels were each added to 108.5 g extraction agent mixture that were each heated to 65° C. The composition of the extraction agent mixture was a volumetric ratio of n-hexane and 2-propanol between 45:55 and 85:15. The peels were stirred gently and left in the extraction solvent for 15 min. The extraction solvent laden with etheric oil and the peels were next separated via filtration. Remaining extraction solvent was removed from the peels via 30-second centrifugation at 180 rpm. The solvent mixture was removed from the extract obtained via evaporation at 90° C. and ambient pressure.

The best results were achieved with the extraction mixtures that have a hexane proportion between 64 and 74% by volume. Using this composition, 0.99 g of orange oil was thus obtained from the 104.3 g batch, which corresponds to an extraction efficiency of 98% at a theoretic etheric oil content of 0.97% of the moist mass or a theoretic etheric oil amount of 1.01 g in the batch. Outside the indicated range, the extraction efficiency collapsed steeply into unacceptable and technically irrelevant values.

Similar extraction efficiencies could be achieved in the extraction of peels of bitter oranges, lemons and citrons, wherein here too the optimal extraction mixtures stood at a hexane proportion between 62 and 76% by volume of hexane.

### EXAMPLE 2

### Extraction of Etheric Oil from Fresh Peppermint

The oil content of the peppermint was determined via Soxhlet extraction at 0.7% by weight of the moist mass and 5% of the dry mass and the water content of the peppermint at 86% by weight.

The peppermint plants were coarsely comminuted and every 200 g were fed for 15 minutes into an extraction agent mixture of 65% by volume ±5% hexane and 35% by volume ±5% 2-propanol that was heated to 65° C. The extraction solvent laden with etheric oil and plant parts was next separated via filtration. Remaining extraction solvent was removed from the plant parts by 30-second centrifugation at 180 rpm. The solvent was removed from the extract obtained by evaporation at 90° C. and ambient pressure. Approximately 1.3 g of mint oil could be obtained in this manner, which corresponds to an extraction efficiency of 93% at a theoretic etheric oil content of 0.7% by weight of the moist mass or a theoretic etheric oil amount of 1.4 g per batch.

### EXAMPLE 3

### Extraction of Etheric Oil from Thyme

The oil content of the thyme was determined by Soxhlet extraction at 0.28% by weight of the moist mass and 1.65% of the dry mass and the water content of the thyme at 83% by weight.

The thyme was coarsely comminuted to pieces 1 mm in size and every 300 g were fed for 15 minutes into an extraction agent mixture of 67% by volume ±5% hexane and 33% by volume ±5% 2-propanol that was heated to 65° C.

The extraction solvent laden with etheric oil and the comminuted thyme was next separated via filtration. Remaining extraction solvent was removed from the comminuted thyme by 30-second centrifugation at 180 rpm. The solvent was removed from the extract obtained by evaporation at 90° C. and ambient pressure. Respectively 0.81 g of thyme oil from each batch could be obtained in this manner, which corresponds to an extraction efficiency of greater than 96% at a theoretic oil content of 0.28% by weight of the moist mass or a theoretic oil amount of 0.84 g per batch.

### EXAMPLE 4

### Extraction of Etheric Oil from Lavender Blossoms

The oil content of the lavender blossoms was determined via Soxhlet extraction at 1.6% by weight of the moist mass and 7.6% of the dry mass and the water content of the lavender blossoms at 79% by weight.

The blossoms were roughly comminuted to 1 cm-large pieces and every 100 g were fed for 15 minutes to a moist extraction solvent of 63% by volume ±5% hexane and 37% by volume ±5% 2-propanol, which was heated to 65° C. The extraction solvent laden with etheric oil and the blossoms were next separated via filtration. Remaining extraction solvent was removed from the blossoms by 30-second centrifugation at 180 rpm. The solvent was removed from the extract obtained by evaporation at 90° C. Approximately 1.5 g of lavender blossom oil could be obtained in this manner, which corresponds to an extraction efficiency of almost 94% at a theoretic oil content of 1.6% by weight of the moist mass or a theoretic oil amount of 1.6 g per batch.

TABLE 1

| Solvent | Dielectric constant ∈ at 25° C. | Polarity |
|---|---|---|
| n-hexane | 1.9 | Non-polar |
| Benzene | 2.3 | Non-polar |
| Diethylether | 4.3 | Non-polar |
| Chloroform | 4.8 | Non-polar |
| 2-propanol | 18.2 | Polar |
| Ethanol | 34.3 | Polar |
| Methanol | 33.6 | Polar |
| Water | 80.4 | Very polar |

TABLE 2
Typical compounds that occur in etheric oils
(from https://de.wikipedia.org/wiki/%C3%84therische_%C3%96le)

| Substance group | | Acyclical | Monocyclical | Bicyclical |
|---|---|---|---|---|
| Mono- | Hydro- | Ocimene, | Limonene | α-pinene |
| terpenes | carbons | myrcene | α-terpene | Camphene |
| | | | Phellandrene | |
| | Alcohols | Linalool | Menthol | Sabinol |
| | | Geraniol | | Borneol |
| | Aldehyde | Neral | | |
| | | citronellal | | |
| | Ketone | | Carvone | Camphor |
| | | | Menthone | Fenchone |
| | Ether | | Menthofurane | |
| | | | Cineole | |
| | | | Anethofurane | |
| | Ester | Geanyl | | Acetic-acid |
| | | acetate | | bornyl ester |
| | | Linalyl | | Iso bornyl |
| | | acetate | | acetate |

| | | | |
|---|---|---|---|
| Sesquiterpenes | Farnesol | α-bisabolol | Chamazulene |
| | Farnesene | α-caryophyllene | β-caryophyllene |

| | |
|---|---|
| Substance group | Examples |

| | | |
|---|---|---|
| Aromates | Phenols | Carveol |
| | | Carvacrol |
| | | Thymol |
| | Phenylpropanoids | Apiole |
| | | Zimataldehyde |
| | | Anethole |
| | | Dillapiol |
| | | Estragole |
| | Furanocumarines | Coriandrine |

1. A method for obtaining etheric oils and/or constituents of etheric oils from moist extraction material containing etheric oils and/or constituents of etheric oils comprising the following steps:
a) extraction of the moist extraction material with an extraction agent mixture comprising at least one polar and at least one non-polar solvent for obtaining a miscella,
wherein the extraction material is selected from citrus fruit peel and/or residues from the juice production from citrus fruits and/or herbs,
wherein the extraction material has a residual moisture content of 5 to 95% by mass, measured on the total mass of the extraction material,
wherein the extraction agent mixture contains at least one non-polar solvent in a proportion of 45 to 95% by volume, measured on the total volume of the extraction agent mixture,
wherein the extraction agent mixture has a temperature above ambient temperature but below the boiling point of the lowest boiling-point solvent or of the lowest boiling-point azeotrope of the extraction agent mixture,
b) separating the miscella from the extraction material,
c) Distillative separation of the miscella.

2. The method according to claim 1, characterized in that the extraction material contains terpenes, terpenoids, sesquiterpenes and aromatic compounds.

3. The method according to claim 1, characterized in that the extraction material has a content of etheric oils and/or the constituents of etheric oils from 0.005 to 10% by mass, measured on the total dry mass of the extraction agent mixture.

4. The method according to claim 1, characterized in that hexane, benzene, kerosene, toluene and/or at least one alkane with 5 to 25 carbon atoms and/or a mixture of these is used as the non- polar solvent.

5. The method according to claim 1, characterized in that the extraction agent mixture contains at least one polar solvent in a proportion of 5 to 55% by volume, measured on the total mass of the extraction agent mixture.

6. The method according to claim 1, characterized in that at least one alcohol containing 1 to 10 carbon atoms or a mixture of these alcohols is used as the polar solvent.

7. The method according to claim 1, characterized in that the extraction agent mixture contains additional polar and/or non-polar solvents in a total volumetric proportion of 0.5 to 40% by volume measured on the total volume of the extraction agent mixture.

8. The method according to claim 1, characterized in that the extraction material is conditioned to an average particle size of from 0.001 to 10 mm.

9. The method according to claim 1, characterized in that the distillative separation of the non-polar solvent out of the separated miscella takes place first and then the separation of the separating non-polar constituents of the etheric oil.
